(19) United States
(12) Patent Application Publication
(10) Pub. No.: US 2025/0296332 A1
(43) Pub. Date: Sep. 25, 2025

(54) LIQUID EJECTION HEAD AND LIQUID EJECTION APPARATUS

(71) Applicant: RISO Technologies Corporation, Tokyo (JP)

(72) Inventors: Masashi SHIMOSATO, Mishima Shizuoka (JP); Noboru NITTA, Mishima Shizuoka (JP)

(21) Appl. No.: 19/025,840

(22) Filed: Jan. 16, 2025

(30) Foreign Application Priority Data
Mar. 25, 2024 (JP) 2024-047996

(51) Int. Cl. B41J 2/14; B41J 2/045

(52) U.S. Cl. CPC B41J 2/14274; B41J 2/04541; B41J 2/04581; B41J 2/1433; B41J 2002/14491

(57) ABSTRACT

A liquid ejection head includes a nozzle plate including nozzles arranged in a first direction, pressure chambers arranged along the first direction and capable of storing liquid, each pressure chamber communicating with one of the nozzles, a structure including a first base portion continuously extending along the first direction and first actuator elements separate from each other, each actuator element extending from the first base portion to one of the pressure chambers, first electrodes separate from each other, each first electrode extending from one side surface of the base portion to one side surface of one of the actuator elements, and a first driving circuit connected to each of the first electrodes on said one side surface of the first base portion and configured to output signals for actuating the first actuator elements to the first electrodes.

### CROSS-REFERENCE TO RELATED APPLICATION

This application is based upon and claims the benefit of priority from Japanese Patent Application No. 2024-047996, filed on Mar. 25, 2024, the entire contents of which are incorporated herein by reference.

### FIELD

Embodiments described herein relate generally to a liquid ejection head and a liquid ejection apparatus.

### BACKGROUND

A piezoelectric actuator using a piezoelectric body such as lead-zirconate-titanate (PZT) is used as a drive source of a liquid ejection apparatus such as an ink jet printer head. For example, a configuration is known in which a plurality of grooves are formed in a piezoelectric body serving as an actuator member, and a columnar piezoelectric element formed by dividing the piezoelectric body is used as an actuator. For example, an actuator member is formed by forming, in a piezoelectric body, a groove having a depth from one side of the piezoelectric body to an intermediate portion. In this manner, the one side is divided into a plurality of pieces and the other side are coupled. External electrodes on one side of an actuator are individual electrodes to each of which a drive voltage is applied, and external electrodes on the other side are common electrodes to which the same voltage which may be 0 V is constantly applied. The individual electrodes are separated between a plurality of actuators, and the common electrodes are connected. For example, the individual electrodes may be separated by cutting out a corner on one side of the piezoelectric body. In such an actuator, since the piezoelectric element is brittle and has a fine shape, it is difficult to ensure ease of mounting.

### BRIEF DESCRIPTION OF THE DRAWINGS

FIG. 1 is a cross-sectional view illustrating a configuration of an ink jet head according to an embodiment.

FIG. 2 is a cross-sectional view illustrating the configuration of the ink jet head.

FIG. 3 is a side view illustrating one side of an actuator portion.

FIG. 4 is a side view illustrating the other side.

FIG. 5 is a diagram illustrating a manufacturing method.

FIG. 6 is a diagram illustrating a schematic configuration of an ink jet printing apparatus.

FIG. 7 is a diagram illustrating a manufacturing method according to another embodiment.

### DETAILED DESCRIPTION

Embodiments of this disclosure provide a liquid ejection head and a liquid ejection apparatus capable of improving ease of mounting.

In general, according to one embodiment, a liquid ejection head comprises a nozzle plate including a plurality of nozzles arranged in a first direction, a plurality of pressure chambers arranged along the first direction and capable of storing liquid, each of the pressure chambers communicating with a corresponding one of the nozzles, a first actuator structure including a first base portion continuously extending along the first direction and a plurality of first actuator elements that are separate from each other, each of the first actuator elements extending from the first base portion to a corresponding one of the pressure chambers, a plurality of first electrodes that are separate from each other, each of the first electrodes extending from one side surface of the first base portion to one side surface of a corresponding one of the first actuator elements, and a first driving circuit connected to each of the first electrodes on said one side surface of the first base portion and configured to output signals for actuating the first actuator elements to the first electrodes.

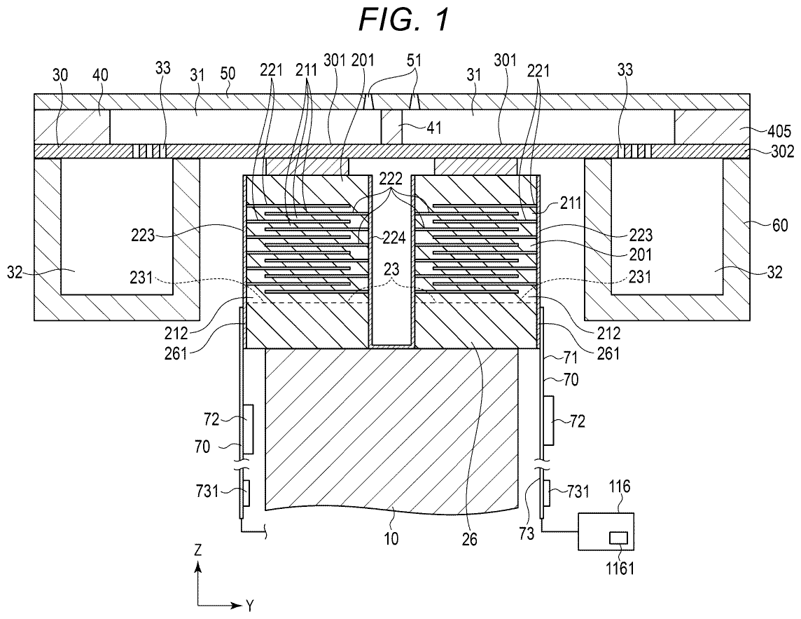

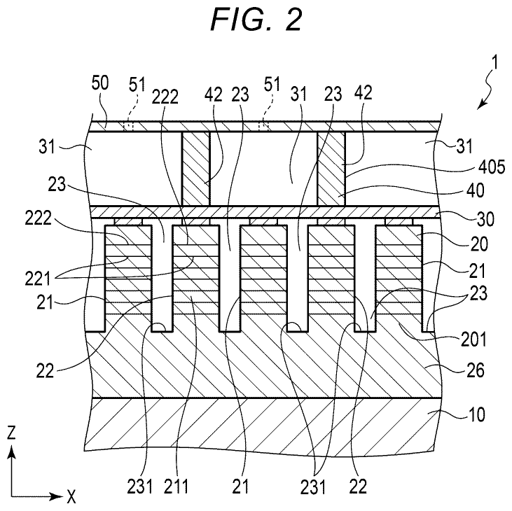

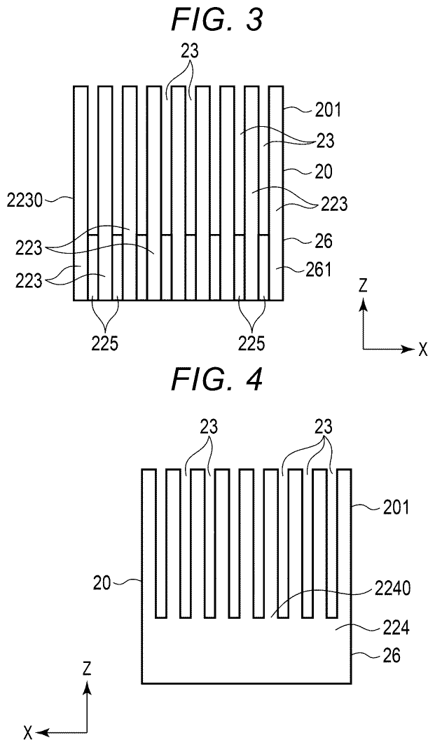

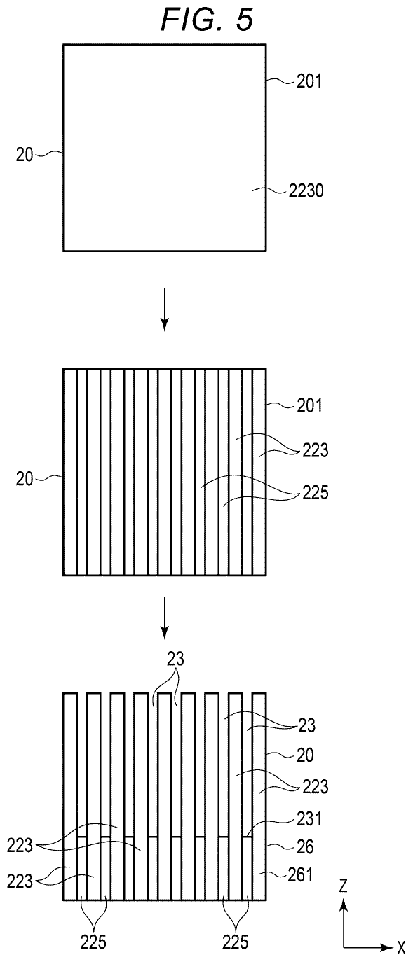

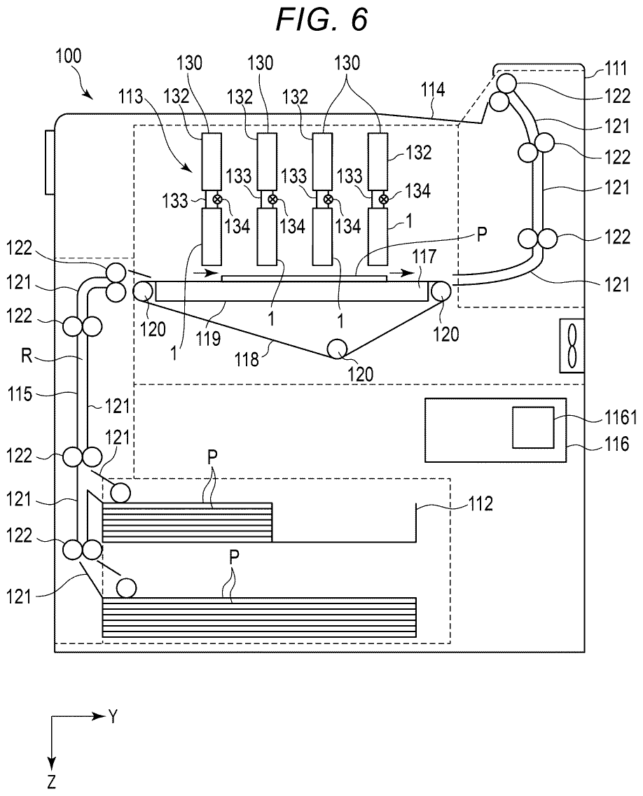

Hereinafter, an ink jet head 1 that is a liquid ejection head and an ink jet printing apparatus 100 that is a liquid ejection apparatus according to an embodiment will be described with reference to FIGS. 1 to 6. FIGS. 1 and 2 are cross-sectional views schematically illustrating a configuration of the ink jet head 1. FIG. 3 is a side view illustrating an individual electrode side, and FIG. 4 is a side view illustrating a common electrode side. FIG. 5 is a diagram illustrating a manufacturing process of the ink jet head 1, and FIG. 6 is a diagram illustrating a schematic configuration of the ink jet printing apparatus 100. Arrows X, Y, and Z in the drawings indicate three directions orthogonal to one another. In the drawings, a configuration is illustrated enlarged, reduced, or omitted as appropriate for the purpose of description.

As shown in FIGS. 1 and 2, the ink jet head 1 includes a support base 10, a pair of actuator portions 20 (hereinafter also referred to as a pair of actuator structures 20), a flow path member 40, a nozzle plate 50 including a plurality of nozzles 51, a frame portion 60 serving, and a drive circuit 70.

For example, the ink jet head 1 includes two actuator portions 20, and includes two nozzle rows in which the plurality of nozzles 51 are arranged in a row direction (i.e., X direction), two pressure chamber rows in which a plurality of pressure chambers 31 are arranged in the row direction, and two element rows in which a plurality of piezoelectric elements 21 and 22 are arranged in the row direction. Here, an example is illustrated in which a stacking direction of a plurality of piezoelectric layers 211, a vibration direction of the piezoelectric elements 21, and a vibration direction of a vibration plate 30 are along Z direction.

The support base 10 supports the pair of actuator portions 20. The support base 10 has, for example, a plate shape. The support base 10 may be a circuit board.

The actuator portions 20 are provided on one side of the support base 10. For example, the two actuator portions 20 are arranged in Y direction.

As illustrated in FIGS. 1 to 4, the actuator portion 20 includes a plurality of the drive piezoelectric elements 21 and a plurality of the non-drive piezoelectric elements 22 that are formed of, for example, piezoelectric members and are actuators alternately arranged along the row direction, and a coupling portion 26 that integrally couples the plurality of piezoelectric elements 21 and 22 on a side close to the support base 10. The piezoelectric member is a stacked piezoelectric member 201 in which the plurality of piezoelectric layers 211 and a plurality of internal electrodes 221 and 222 are stacked.

In the actuator portion 20, the plurality of drive piezoelectric elements 21 and the plurality of non-drive piezoelectric elements 22 are arranged in one direction at regular intervals.

For example, the plurality of drive piezoelectric elements 21 and the plurality of non-drive piezoelectric elements 22 are formed in rectangular columnar shapes having the same outer shape. The actuator portion 20 is divided into the plurality of drive piezoelectric elements 21 and non-drive piezoelectric elements 22 on one end side by forming a plurality of grooves 23 from one side. The plurality of drive piezoelectric elements 21 and non-drive piezoelectric elements 22 are arranged in the row direction at the same pitch by the grooves 23 having the same width in an arrangement direction. Since a depth of the groove 23 of the actuator portion 20 is set to be smaller than the entire length of a dimension of the actuator portion 20 in the Z direction, the coupling portion 26 that integrally couples the plurality of elements 21 and 22 is formed on a side that is closer to the support base 10 than is a bottom surface 231 of the groove 23.

The coupling portion 26 is a block-shaped member that is disposed on a base end side of the plurality of piezoelectric elements 21 and 22 and that couples the plurality of piezoelectric elements 21 and 22. That is, the coupling portion 26 is formed in a plate shape that has a longitudinal direction extending in the X direction and is continuous over the entire length of the stacked piezoelectric member 201 in the longitudinal direction. The coupling portion 26 has a thickness dimension along the Z direction of 0.5 mm or more. Individual electrodes constituting external electrodes 223 are formed on one side surface that is an end surface of the coupling portion 26 in the Y direction different from the Z direction. The individual electrodes are, for example, a plurality of line patterns separated from one another on one side surface of the coupling portion 26. In other words, a plurality of the external electrodes 223 which are line patterns separated from one another, and electrode removed portions 225 where electrode layers 2230 between the plurality of external electrodes 223 are removed by PEP (Photo Engraving Process) or the like are alternately formed on the one side surface of the coupling portion 26.

One side surface portion constitutes a mounting portion 261 on which anisotropic conductive film (ACF) mounting or solder mounting is to be performed. For example, a flexible printed circuit (FPC) 71 is electrically and mechanically connected to the individual electrodes on the one side surface of the coupling portion 26 by solder mounting or ACF mounting. For example, the one side surface where the mounting portion 261 is formed and the other side surface on an opposite side form a plane orthogonal to the stacking direction.

A common electrode constituting an external electrode 224 is formed on a side surface of the coupling portion 26 on the other side in the Y direction. The common electrode includes an electrode layer 2240 formed on the entire other side surface of the coupling portion 26.

For example, the depth of the groove 23 is set to a depth at which the coupling portion 26 can secure a size of the mounting portion 261. For example, when the groove 23 is formed from one side in the Z direction of the stacked piezoelectric member 201, the depth of the groove 23 from the one side in the Z direction of the stacked piezoelectric members 201 is made smaller than that from an end portion on a side close to the support base 10, thereby ensuring a dimension of the mounting portion 261 being a mountable dimension at, for example, 0.5 mm or more.

For example, the plurality of drive piezoelectric elements 21 and the plurality of non-drive piezoelectric elements 22 are formed in a rectangular shape having a short side direction along the row direction of an element row and a longitudinal direction along an extending direction that is orthogonal to the row direction and the Z direction in a plan view as viewed from the Z direction.

The drive piezoelectric elements 21 are arranged at positions facing the plurality of the pressure chambers 31 formed in the flow path member 40 in the Z direction. For example, a center position of the drive piezoelectric element 21 in the row direction and the extending direction and a center position of the pressure chamber 31 in the row direction and the extending direction are aligned in the Z direction.

The non-drive piezoelectric elements 22 are arranged at positions facing a plurality of partition wall portions 42 formed in the flow path member 40 in the Z direction. For example, a center position of the non-drive piezoelectric element 22 in the row direction and the extending direction and a center position of the partition wall portion 42 in the row direction and the extending direction are aligned in the Z direction.

For example, the actuator portion 20 is formed with the grooves 23 by dicing the stacked piezoelectric member 201 joined to the support base 10 in advance from an end surface on an opposite side to the support base 10, thereby forming, at predetermined intervals, a plurality of piezoelectric elements each having a rectangular columnar shape. Electrode layers are formed on a plurality of the formed columnar elements to form the plurality of drive piezoelectric elements 21 and the plurality of non-drive piezoelectric elements 22 that are arranged alternately. The plurality of drive piezoelectric elements 21 and the plurality of non-drive piezoelectric elements 22 are alternately arranged in parallel in a manner of sandwiching the grooves 23 in the row direction.

For example, the stacked piezoelectric member 201 constituting the actuator portion 20 is formed by stacking and sintering sheet-shaped piezoelectric materials.

A piezoelectric member constituting the drive piezoelectric elements 21 and the non-drive piezoelectric elements 22 is, for example, the stacked piezoelectric member 201. Each of the drive piezoelectric element 21 and the non-drive piezoelectric element 22 includes a plurality of stacked piezoelectric layers 211 and internal electrodes 221 and 222 formed on a main surface of each of the piezoelectric layers 211. For example, the drive piezoelectric elements 21 and the non-drive piezoelectric elements 22 have the same stacked structure. Each of the drive piezoelectric elements 21 and the non-drive piezoelectric elements 22 includes the external electrodes 223 and 224 formed on surfaces thereof.

The piezoelectric layer 211 is formed in a thin plate shape from a piezoelectric ceramic material such as a PZT based material or a lead-free KNN (sodium potassium niobate) based material. The plurality of piezoelectric layers 211 are stacked with a thickness direction aligned along the stacking direction, and are joined to one another. For example, in the present embodiment, the thickness direction and the stacking direction of the piezoelectric layers 211 are along the vibration direction (i.e., the Z direction).

The internal electrodes 221 and 222 are conductive films formed in a predetermined shape and formed of a sinterable conductive material such as silver palladium. The internal electrodes 221 and 222 are formed in predetermined regions on the main surfaces of the piezoelectric layers 211. The internal electrodes 221 and 222 have different poles. For example, the internal electrode 221 is formed in a region reaching one end portion of the piezoelectric layer 211 and not reaching the other end portion of the piezoelectric layer 211 in the extending direction (i.e., the Y direction) orthogonal to both the vibration direction (i.e., the Z direction) and the row direction (i.e., the X direction) which is an arrangement direction of the plurality of drive piezoelectric elements 21 and the plurality of non-drive piezoelectric elements 22. The internal electrode 222 is formed in a region not reaching the one end portion of the piezoelectric layer 211 but reaching the other end portion of the piezoelectric layer 211 in the extending direction. The internal electrodes 221 and 222 are connected to the external electrodes 223 and 224 formed on side surfaces of the piezoelectric elements 21 and 22.

The stacked piezoelectric member 201 constituting the drive piezoelectric elements 21 and the non-drive piezoelectric elements 22 further includes a dummy layer 212 on either one or both of an end portion on a side close to the support base 10 and an end portion close to the nozzle plate 50. The dummy layer 212 is formed of, for example, the same material as the piezoelectric layer 211, has an electrode only on one side, and is not deformed because no electric field is applied thereto. For example, the dummy layer 212 does not function as a piezoelectric body, but serves as a base for fixing the actuator portion 20 to the support base 10, or serves as a polishing allowance for polishing to improve accuracy during assembly and after assembly.

The external electrodes 223 and 224 are formed on surfaces of the plurality of drive piezoelectric elements 21 and the plurality of non-drive piezoelectric elements 22, and are formed by collecting ends of the internal electrodes 221 and 222. For example, the external electrode 223 is formed on one end surface of the piezoelectric layer 211 in the extending direction. The external electrode 224 is formed on the other end surface of the piezoelectric layer 211 in the extending direction.

The external electrodes 223 and 224 are formed of Ni, Cr, Au, or the like by a known method such as plating or sputtering. The external electrode 223 and the external electrode 224 have different poles. The external electrode 223 and the external electrode 224 are disposed on different side surface portions of the plurality of drive piezoelectric elements 21 and the plurality of non-drive piezoelectric elements 22.

For example, the external electrodes 223 are individual electrodes, and the external electrode 224 is a common electrode. The external electrodes 223 serving as individual electrodes of the plurality of drive piezoelectric elements 21 and the plurality of non-drive piezoelectric elements 22 are arranged independently of one another by patterning the electrode layers 2230 formed on one side surface of the stacked piezoelectric member 201 in a manufacturing process. That is, the external electrodes 223 on one side are divided by the grooves 23, and the electrode layers 2230 are divided by patterning at a side surface portion of the coupling portion 26 on a side close to the support base 10, so that the external electrodes 223 are formed as a plurality of individual electrodes that are separated from one another in the parallel direction and are independent of one another.

The external electrodes 223 are connected to the drive circuit 70 via the FPC 71 serving as a flexible substrate which is an example of a wiring substrate at the mounting portion 261 on a side surface of the coupling portion 26. For example, each of the external electrodes 223 is connected to a control unit 116 serving as a drive unit by the FPC 71 via a drive IC 72 of the drive circuit 70, and is driven under the control of a control circuit 1161. The external electrode 224 may be routed to a side surface of the external electrode 223 and connected to the drive circuit 70 via the FPC 71.

By forming the grooves 23 to be shallower at an end portion of the electrode layer 2240 on the side close to the support base 10, the electrode layer 2240 on the other side surface of the piezoelectric member 201 is continuous in a region from bottom portions of the grooves 23 to the side close to the support base 10, and thus the external electrode 224 formed on an end surface on the other side of the actuator is formed as a common electrode. For example, the external electrode 224 is grounded.

The dummy layer 212 is made of the same material as the piezoelectric layer 211. The dummy layer 212 has an electrode only on one side, and is not deformed because no electric field is applied. That is, the dummy layer 212 does not function as a piezoelectric body, and serves as a base at the time of fixing, or serves as a polishing allowance for polishing to improve accuracy during assembly and after assembly.

A vibration direction of the piezoelectric elements 21 and 22 is along the stacking direction, and the piezoelectric elements 21 and 22 are displaced in a d33 direction (i.e., the Z direction) when an electric field is applied.

For example, the number of stacked layers in each of the piezoelectric elements 21 and 22 is three or more and 50 or less, a thickness of each layer is 10 μm or more and 40 μm or less, and a product of the thickness and the total number of stacked layers is less than 1000 μm.

The drive piezoelectric element 21 vibrates when a voltage is applied to the internal electrodes 221 and 222 via the external electrodes 223 and 224. Here, the drive piezoelectric elements 21 perform longitudinal vibration along the stacking direction of the piezoelectric layers 211. The term “longitudinal vibration” referred to here is, for example, “vibration in a thickness direction defined by a piezoelectric constant d33”. The drive piezoelectric element 21 displaces the vibration plate 30 and deforms the pressure chamber 31 by the longitudinal vibration.

The flow path member 40 includes the vibration plate 30 that faces one side of the actuator portion 20 in a deformation direction, and a flow path substrate 405 stacked on one side of the vibration plate 30.

The vibration plate 30 is provided between the flow path substrate 405 and the actuator portion 20 in the vibration direction. The vibration plate 30 constitutes the flow path member 40 together with the flow path substrate 405. The vibration plate 30 extends in a direction intersecting a side surface of the stacked piezoelectric member 201 where the individual electrodes and the common electrode are formed.

The vibration plate 30 extends along a plane orthogonal to the Z direction which is the vibration direction, and is joined to one side in the vibration direction of the piezoelectric layers 211 of the plurality of piezoelectric elements 21 and 22, that is, a surface on a side close to the nozzle plate 50. For example, the vibration plate 30 is deformable. The vibration plate 30 is joined to the drive piezoelectric elements 21 and the non-drive piezoelectric elements 22 of the actuator portion 20 and the frame portion 60. For example, the vibration plate 30 has a vibration region 301 facing the piezoelectric elements 21 and 22 and a support region 302 facing the frame portion 60.

The vibration region 301 has, for example, a flat plate shape disposed such that a thickness direction is the vibration direction of the piezoelectric layer 211. A plane direction of the vibration plate 30 extends in an arrangement direction of the plurality of drive piezoelectric elements 21 and the plurality of non-drive piezoelectric elements 22. The vibration plate 30 is, for example, a metal plate. The vibration plate 30 has a plurality of vibration portions that face the respective pressure chambers 31 and can be displaced individually. The vibration plate 30 is formed by integrally coupling the plurality of vibration portions.

For example, the vibration plate 30 is formed of a nickel plate or a stainless steel plate (SUS) plate, and a thickness dimension thereof along the vibration direction is about 5 μm to 15 μm. In the vibration region 301, a fold or a step may be formed at a portion adjacent to the vibration portion or between adjacent vibration portions so that the plurality of vibration portions are easily displaced. The vibration region 301 is deformed by displacing a portion that faces the drive piezoelectric element 21 due to expansion and compression of the drive piezoelectric element 21. For example, since the vibration plate 30 needs to have a very thin and complicated shape, the vibration plate 30 is formed by electroforming or the like. The vibration plate 30 is joined to an upper end surface of the actuator portion 20 by adhesion or the like.

The support region 302 is a plate-shaped member disposed between the frame portion 60 and the flow path substrate 405. The support region 302 includes a communication portion 33 having a through hole for communicating with a common chamber 32.

For example, the communication portion 33 includes a filter member having a large number of pores through which liquid can pass as the through holes.

The flow path substrate 405 is disposed between the nozzle plate 50 and the vibration plate 30 in the vibration direction. The flow path substrate 405 is joined to one side of the vibration plate 30 in the vibration direction.

The flow path substrate 405 includes a wall member such as a guide wall portion 41 and the partition wall portion 42, and is formed with a predetermined ink flow path including the plurality of pressure chambers 31 separated from one another and a plurality of individual flow paths that communicate with the pressure chambers 31 separated from one another and the common chamber 32.

In the flow path substrate 405, the plurality of pressure chambers 31 are separated by the partition wall portions 42. That is, both sides in the parallel direction of the pressure chamber 31 are formed by the partition wall portions 42. Each pressure chamber 31 communicates with the nozzle 51 formed in the nozzle plate 50 disposed on one side. The pressure chamber 31 is closed by the vibration plate 30 on a side opposite to the nozzle plate 50.

The plurality of pressure chambers 31 are spaces formed on one side of the vibration region 301 of the vibration plate 30, and communicate with the common chamber 32 via the individual flow paths and the communication portion 33. The plurality of pressure chambers 31 communicate with the nozzles 51 formed in the nozzle plate 50. The pressure chambers 31 are closed by the vibration plate 30 on a side opposite to the nozzle plate 50.

The plurality of pressure chambers 31 hold a liquid supplied from the common chamber 32, and the pressure chambers 31 are deformed by vibration of the vibration plate 30 that forms a part of the pressure chamber 31, thereby ejecting the liquid from the nozzles 51.

The partition wall portions 42 are wall members that separate the plurality of pressure chambers 31 arranged in the parallel direction and form both side portions of the pressure chambers 31. The partition wall portion 42 is disposed in a manner of facing the non-drive piezoelectric element 22 via the vibration plate 30, and is supported by the non-drive piezoelectric element 22. A plurality of the partition wall portions 42 are provided at a pitch the same as an arrangement pitch of the pressure chambers 31.

The nozzle plate 50 is formed of a metal such as SUS and Ni, or a resin material such as polyimide, and has a rectangular plate shape with a thickness of about 10 μm to 100 μm. The nozzle plate 50 is disposed on one side of the flow path substrate 405 in a manner of covering an opening on one side of the pressure chamber 31.

The plurality of nozzles 51 are arranged in a first direction the same as the arrangement direction of the pressure chambers 31 to form a nozzle row. For example, two rows of the nozzles 51 are provided, and the nozzles 51 are provided at positions corresponding to the plurality of pressure chambers 31 arranged in two rows. For example, the nozzles 51 are provided at positions of end portions of the pressure chambers 31 in the extending direction.

The frame portion 60 is a structure joined to the vibration plate 30 together with the piezoelectric elements 21 and 22. The frame portion 60 is provided on a side of the piezoelectric elements 21 and 22 and a side of the vibration plate 30 opposite to the flow path substrate 405. For example, the frame portion 60 is adjacent to the actuator portion 20. The frame portions 60 constitute an outer shell of the ink jet head 1. Further, the frame portion 60 may be formed with a liquid flow path therein. For example, the frame portion 60 is joined to the other side of the vibration plate 30, and the common chamber 32 is formed between the frame portion 60 and the vibration plate 30.

The common chamber 32 is formed inside the frame portion 60 and communicates with the pressure chamber 31 through the communication portion 33 provided in the vibration plate 30 and the individual flow paths.

The drive circuit 70 includes the FPC 71 connected to the actuator portion 20 via various kinds of wiring, the drive IC 72 mounted on the FPC 71, and a printed wiring board 73 mounted on the other end of the FPC 71.

The drive circuit 70 drives the drive piezoelectric element 21 by applying a drive voltage to the external electrodes 223 and 224 by the drive IC 72, increases or decreases a volume of the pressure chamber 31, and causes droplets to be ejected from the nozzle 51.

The FPC 71 is connected to the mounting portion 261 on a side surface of the coupling portion 26, and is connected to the plurality of external electrodes 223 and 224 of the actuator portion 20. A chip on film (COF) on which the drive IC 72 is mounted as an electronic component is used as the FPC 71.

The drive IC 72 is connected to the external electrodes 223 and 224 via the FPC 71. The drive IC 72 is an electronic component used for ejection control.

The drive IC 72 generates a control signal and a drive signal for operating each drive piezoelectric element 21. The drive IC 72 generates the control signal for controlling a timing of ejecting ink, selection of the drive piezoelectric element 21 to eject the ink, and so on, according to an image signal received from the control unit 116 of the ink jet printing apparatus 100 in which the ink jet head 1 is mounted. The drive IC 72 generates a voltage to be applied to the drive piezoelectric element 21, that is, a drive signal, according to the control signal from the control unit 116. When the drive IC 72 applies the drive signal to the drive piezoelectric element 21, the drive piezoelectric element 21 is driven to displace the vibration plate 30 and change a volume of the pressure chamber 31. Accordingly, ink filled in the pressure chamber 31 are caused to perform pressure vibration. Due to the pressure vibration, the ink is ejected from the nozzle 51 communicating with the pressure chamber 31. The ink jet head 1 may be configured to implement gradation expression by changing an amount of ink droplets that land on one pixel. The ink jet head 1 may be configured to change the amount of ink droplets that land on one pixel by changing the number of times of ink ejection. As described above, the drive IC 72 is an example of an application unit that applies a drive signal to the drive piezoelectric element 21.

For example, the drive IC 72 includes a data buffer, a decoder, and a driver. The data buffer stores printing data in time series for each drive piezoelectric element 21. The decoder controls the driver based on the printing data stored in the data buffer for each drive piezoelectric element 21. The driver outputs a drive signal for operating each drive piezoelectric element 21 based on the control of the decoder. The drive signal is, for example, a voltage signal to be applied to each drive piezoelectric element 21.

The printed wiring board 73 is a printing wiring assembly (PWA) on which various electronic components and connectors are mounted, and includes a head control circuit 731. The printed wiring board 73 is connected to the control unit 116 of the ink jet printing apparatus 100.

In the ink jet head 1 configured as described above, the nozzle plate 50, the frame portion 60, the flow path substrate 405, and the vibration plate 30 form an ink flow path including the plurality of pressure chambers 31 communicating with the nozzles 51 and the common chamber 32 communicating with the plurality of pressure chambers 31. For example, the common chamber 32 communicates with a cartridge, and the ink is supplied to the pressure chambers 31 through the common chamber 32. All of the drive piezoelectric elements 21 are connected by wiring so that a voltage can be applied thereto. In the ink jet head 1, for example, when the control unit 116 of the ink jet printing apparatus 100 causes the drive IC 72 to apply a drive voltage to the electrodes 221 and 222, the drive piezoelectric element 21 to be driven vibrates, for example, in the stacking direction, that is, in the thickness direction of the piezoelectric layers 211. That is, the drive piezoelectric element 21 vibrates longitudinally.

Specifically, the control unit 116 selectively drives the drive piezoelectric element 21 to be driven by applying a drive voltage to the internal electrodes 221 and 222 of the drive piezoelectric element 21 to be driven. Then, the vibration plate 30 is deformed and the volume of the pressure chamber 31 is changed by the drive piezoelectric element 21 to be driven by combining deformation in a tensile direction and deformation in a compression direction, thereby guiding a liquid from the common chamber 32 and ejecting the liquid from the nozzle 51.

An example of a manufacturing method of the ink jet head 1 will be described with reference to FIG. 5. First, the internal electrodes 221 and 222 are formed by printing on a piezoelectric material formed in a sheet shape. Then, the plurality of piezoelectric layers 211 including the internal electrodes 221 and 222 are stacked, and sintering processing and polarization processing are performed to form the stacked piezoelectric member 201.

Then, the polarization processing of the piezoelectric element 21 of the stacked piezoelectric member 201 in which the internal electrodes 221 and 222 are formed in advance is performed, and the stacked piezoelectric member 201 is attached to the support base 10 with an adhesive or the like. For example, in a case where two of the actuator portions 20 are formed, the stacked piezoelectric member 201 integrally formed may be joined to the support base 10 and then divided into two pieces by groove processing or the like, or two of the stacked piezoelectric members 201 for forming the two actuator portions 20 may be separately prepared.

Then, in a state where the stacked piezoelectric member 201 is disposed on the support base 10, a surface of the support base 10 and a surface of the stacked piezoelectric member 201 are subjected to surface processing by a tool such as a diamond cutter, thereby forming an outer surface of the stacked piezoelectric member 201. Accordingly, it is possible to ensure flatness of an upper surface of the actuator portion 20 to which the vibration plate 30 is to be joined in a subsequent process.

Subsequently, the electrode layers 2230 and 2240 that are to be formed as the external electrodes 223 and 224 are formed on one end surface and the other end surface of the stacked piezoelectric member 201 by printing processing. For example, an electrode may be formed once on a top portion of the actuator portion 20. In this case, the external electrodes 223 and 224 are separated from one another by removing the electrode on the top portion of the actuator portion 20 by polishing or the like.

Next, the electrode layer 2230 formed on one side surface is patterned and divided into individual pieces. For example, in a patterning method, the electrode layer 2230 is partially removed by forming a shallow groove on a surface by a PEP method or laser processing. That is, the electrode layer 2230 formed on an end surface of the stacked piezoelectric member 201 is divided into a plurality of rows in the X direction, and the external electrodes 223 which are a plurality of line patterns corresponding to the pressure chambers 31 and the electrode removed portions 225 where the electrode layers 2230 between the plurality of adjacent external electrodes 223 are partially removed are alternately formed.

Subsequently, a tool such as a diamond cutter is moved in the Z direction to process the electrode layer 2230, thereby forming the plurality of grooves 23 in the actuator portion 20. At this time, the plurality of grooves 23 are formed at the same time at a predetermined pitch, and the stacked piezoelectric member 201 is divided into a plurality of pieces to form a plurality of columnar elements that is the plurality of piezoelectric elements 21 and 22 arranged at the same pitch. Accordingly, the plurality of drive piezoelectric elements 21 and non-drive piezoelectric elements 22 arranged at the same pitch are formed.

Here, a part of the electrode layer 2230 is left such that the groove 23 has a depth at which the groove 23 does not reach the entire length of the actuator portion 20, thereby forming the coupling portion 26 including the mounting portion 261 in a region closer to the support base 10 than is the bottom surface 231 of the groove 23.

After the patterning and the processing of the groove 23, the external electrode 224 serving as the common electrode where the electrode layer 2240 is continuous is formed on the other side surface of the coupling portion 26. Further, the FPC 71 on which an electronic component such as the drive IC 72 is mounted as a control component is coupled to the mounting portion 261 on the side surface of the coupling portion 26 of the actuator portion 20 by, for example, solder mounting or ACF mounting using an anisotropic conductive film. Further, the printed wiring board 73 including the head control circuit 731 is coupled to the FPC 71.

Then, the vibration plate 30, the flow path substrate 405, and the nozzle plate 50 are stacked on the actuator portion 20 via a bonding material and positioning is performed, the frame portion 60 is disposed on an outer periphery of the actuator portion 20, and a plurality of these members are joined to complete the ink jet head 1.

Hereinafter, an example of the ink jet printing apparatus 100 including the ink jet head 1 will be described with reference to FIG. 6. The ink jet printing apparatus 100 includes a housing 111, a medium supply unit 112, an image forming unit 113, a medium discharge unit 114, a conveyance device 115, and the control unit 116.

The ink jet printing apparatus 100 is a liquid ejection apparatus that ejects a liquid such as ink while conveying a print medium that is an ejection target such as a sheet P along a predetermined conveyance path R from the medium supply unit 112 to the medium discharge unit 114 through the image forming unit 113, and thereby performs image forming processing on the sheet P.

The housing 111 constitutes an outer shell of the ink jet printing apparatus 100. A discharge port through which the sheet P is to be discharged to the outside is provided at a predetermined position of the housing 111.

The medium supply unit 112 includes a plurality of sheet feed cassettes, and can hold a plurality of sheets P of various sizes in a manner of stacking the sheets P.

The medium discharge unit 114 includes a sheet discharge tray that can hold the sheet P discharged from the discharge port.

The image forming unit 113 includes a holding portion 117 that holds the sheet P, and a plurality of head units 130 that are disposed in a manner of facing the support portion 117 above the support portion 117.

The holding portion 117 includes a conveyance belt 118 provided in a loop shape in a predetermined region where image formation is performed, a holding plate 119 that holds the conveyance belt 118 from a back side, and a plurality of belt rollers 120 provided on the back side of the conveyance belt 118.

During image formation, the holding portion 117 holds the sheet P on a holding surface that is an upper surface of the conveyance belt 118, and conveys the sheet P to a downstream side by sending the conveyance belt 118 at a predetermined timing by rotation of the belt rollers 120.

The head unit 130 includes a plurality of (e.g., four colors) ink jet heads 1, ink tanks 132 serving as liquid tanks respectively mounted on the ink jet heads 1, connection flow paths 133 that connect the ink jet heads 1 and the ink tanks 132, and supply pumps 134.

For example, the head unit 130 includes the ink jet heads 1 of four colors of cyan, magenta, yellow, and black, and the ink tanks 132 that store ink of the respective colors. The ink tank 132 is connected to the ink jet head 1 by the connection flow path 133.

A negative pressure control device such as a pump (not illustrated) is connected to the ink tank 132. A negative pressure in the ink tank 132 is controlled by the negative pressure control device according to water head values of the ink jet head 1 and the ink tank 132, thereby forming the ink supplied to each nozzle 51 of the ink jet head 1 into a meniscus having a predetermined shape.

The supply pump 134 is, for example, a liquid sending pump formed of a piezoelectric pump. The supply pump 134 is provided in a supply flow path. The supply pump 134 is connected to the control circuit 1161 of the control unit 116 through wiring and can be controlled by the control unit 116. The supply pump 134 supplies a liquid to the ink jet head 1.

The conveyance device 115 conveys the sheet P along the conveyance path R from the medium supply unit 112 to the medium discharge unit 114 through the image forming unit 113. The conveyance device 115 includes a plurality of guide plate pairs 121 disposed along the conveyance path R and a plurality of conveyance rollers 122.

Each of the plurality of guide plate pairs 121 includes a pair of plate members disposed in a manner of facing each other across the sheet P to be conveyed, and guides the sheet P along the conveyance path R.

The conveyance roller 122 is driven and rotated under the control of the control unit 116, thereby conveying the sheet P to the downstream side along the conveyance path R. Sensors that detect a sheet conveyance state are disposed at various positions in the conveyance path R.

The control unit 116 includes the control circuit 1161 such as a central processing unit (CPU) serving as a controller, a read only memory (ROM) that stores various programs, a random access memory (RAM) that temporarily stores various kinds of variable data, image data, and the like, and an interface unit that receives data from the outside and outputs data to the outside.

In the ink jet printing apparatus 100 configured as described above, for example, when the control unit 116 detects a print instruction by a user operating an operation input unit, the control unit 116 drives the ink jet head 1 by driving the conveyance device 115 to convey the sheet P and outputting a printing signal to the head unit 130 at a predetermined timing. As an ejection operation, the ink jet head 1 transmits a drive signal to the drive IC 72 according to an image signal corresponding to image data, and applies a drive voltage to the internal electrodes 221 and 222 to selectively drive the drive piezoelectric element 21 of an ejection target to cause the drive piezoelectric element 21 to vibrate longitudinally, for example, in the stacking direction, thereby changing a volume of the pressure chamber 31 to eject ink from the nozzle 51 and form an image on the sheet P held on the conveyance belt 118. As a liquid ejection operation, the control unit 116 drives the supply pump 134 to supply the ink from the ink tank 132 to the common chamber 32 of the ink jet head 1.

Here, a driving operation for driving the ink jet head 1 will be described. The ink jet head 1 includes the drive piezoelectric elements 21 disposed in a manner of facing the pressure chambers 31, and the drive piezoelectric elements 21 are connected by wiring so that a voltage can be applied thereto. The control unit 116 sends a drive signal to the drive IC 72 according to the image signal corresponding to the image data, and applies a drive voltage to the internal electrodes 221 and 222 of the drive piezoelectric element 21 to be driven, thereby selectively deforming the drive piezoelectric element 21 to be driven. Then, deformation of the vibration plate 30 in a tensile direction and deformation of the vibration plate 30 in a compression direction are combined to change the volume of the pressure chamber 31 to eject a liquid.

For example, the control unit 116 alternately performs a pulling operation and a compressing operation. In the ink jet head 1, at the time of pulling for increasing the internal volume of the target pressure chamber 31, the drive piezoelectric element 21 to be driven is contracted, and the drive piezoelectric element 21 other than a drive target is not deformed. In the ink jet head 1, at the time of compressing for reducing the internal volume of the target pressure chamber 31, the target drive piezoelectric element 21 is extended. The non-drive piezoelectric element 22 is not deformed.

The ink jet head 1 and the ink jet printing apparatus 100 described above can provide a liquid ejection head and a liquid ejection apparatus with high ease of mounting. That is, the actuator portion 20 has a configuration in which one end side is divided and the other end side is coupled, and the mounting portion 261 is provided in the coupling portion 26, so that coupling strength can be ensured and reliability can be improved. That is, since the block-shaped coupling portion 26 where no groove 23 is formed has a withstand load higher than that of a shape formed by a plurality of fine columnar elements, strength of solder bonding can be improved, other methods such as ACF bonding can be adopted, and the reliability can be further improved. The ease of mounting can be further improved by setting a thickness dimension of the coupling portion 26 to be as large as 0.5 mm or more.

The present disclosure is not limited to the embodiments described above, and constituent elements can be modified and embodied in an implementation stage without departing from the gist of the disclosure.

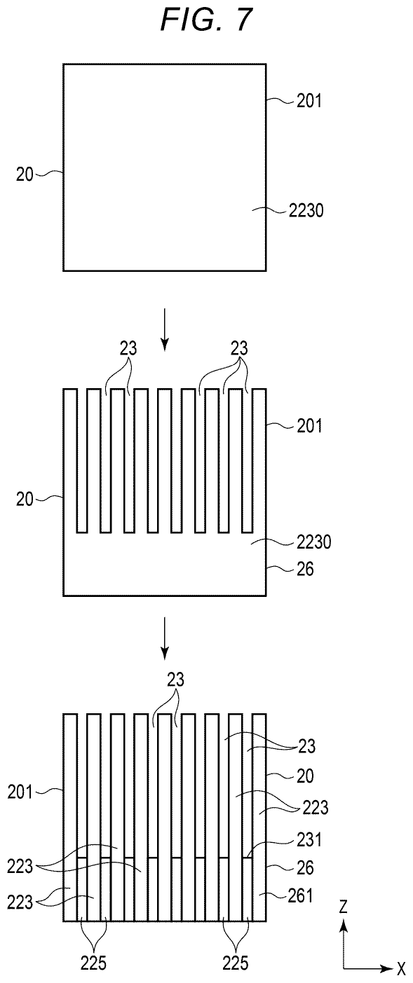

Although an example is described above in which patterning is performed by other methods such as PEP or laser as a process before the groove 23 is formed, the embodiments disclosed herein are not limited thereto. For example, as illustrated in FIG. 7, after the plurality of grooves 23 are formed in the stacked piezoelectric member 201 on which the electrode layer 2230 is formed on the entire surface, the electrode layer 2230 at the coupling portion 26 may be patterned and divided into individual electrodes. In the case of a PEP method, after the grooves 23 are processed, defects such as unevenness and residues are likely to occur since a flow of a processing liquid is different in the vicinity of the grooves 23 and other portions in a WET process. Therefore, it is more preferable to form a pattern before processing the grooves 23 in the PEP method.

Materials and configurations of the piezoelectric elements 21 and 22 are not limited to the embodiments described above, and may be appropriately changed.

Although the drive piezoelectric element 21 formed by stacking the plurality of piezoelectric layers 211 is driven by longitudinal vibration (d33) in the stacking direction in the embodiments described above, embodiments of this disclosure are not limited thereto. For example, the drive piezoelectric element 21 may be applicable to an aspect in which the drive piezoelectric element 21 is formed of a single-layer piezoelectric member, and may be applicable to an aspect in which the drive piezoelectric element 21 is driven by lateral vibration in which the drive piezoelectric element 21 is displaced in a d31 direction.

The arrangement of the nozzles 51 and the arrangement of the pressure chambers 31 are not limited to those in the embodiments described above. For example, the nozzles 51 may be arranged in two or more rows. Air chambers serving as dummy chambers may be formed between the plurality of pressure chambers 31. The ink jet head is not limited to a circulation type, and may be a non-circulation type, or the ink jet head is not limited to an end shooter type, and may be a side shooter type.

Although an example is described in which the piezoelectric elements 21 and 22 include the dummy layers 212 on both sides in the stacking direction, embodiments of this disclosure are not limited thereto. The dummy layer 212 may be provided only on one side of each of the piezoelectric elements 21 and 22, or the piezoelectric elements 21 and 22 may not include the dummy layer 212. In addition, configurations and positional relationships of various components including the flow path member 40, the nozzle plate 50, and the frame portion 60 are not limited to examples described above, and can be appropriately changed.

Although an example is described above in which the two actuator portions 20 are arranged in parallel on the support base 10, embodiments of this disclosure are not limited thereto. The number of the actuator portion 20 may be singular.

The liquid to be ejected is not limited to ink for printing, and for example, the embodiments described herein may be applied to an apparatus that ejects a liquid containing conductive particles for forming a wiring pattern of a printed wiring board.

Although the ink jet head 1 is used in a liquid ejection apparatus such as an ink jet printing apparatus in the embodiments described above, embodiments of this disclosure are not limited thereto. For example, the ink jet head 1 may be used in a 3D printer, an industrial manufacturing machine, and a medical application, and the ink jet head 1 can be reduced in size, weight, and cost.

According to at least one embodiment described above, it is possible to provide a liquid ejection head and a liquid ejection apparatus capable of improving ease of mounting.

While several embodiments of the present disclosure have been described, the embodiments have been presented by way of example and are not intended to limit the scope of the disclosure. These novel embodiments can be implemented in various other forms, and various omissions, substitutions, and modifications can be made without departing from the gist of the disclosure. The embodiments and the modifications thereof are included in the scope and the gist of the disclosure, and are included in the scope of the disclosure disclosed in the claims and equivalents thereof.

What is claimed is:

1. A liquid ejection head comprising:
a nozzle plate including a plurality of nozzles arranged in a first direction;
a plurality of pressure chambers arranged along the first direction and capable of storing liquid, each of the pressure chambers communicating with a corresponding one of the nozzles;
a first actuator structure including a first base portion continuously extending along the first direction and a plurality of first actuator elements that are separate from each other, each of the first actuator elements extending from the first base portion to a corresponding one of the pressure chambers;
a plurality of first electrodes that are separate from each other, each of the first electrodes extending from one side surface of the first base portion to one side surface of a corresponding one of the first actuator elements; and
a first driving circuit connected to each of the first electrodes on said one side surface of the first base portion and configured to output signals for actuating the first actuator elements to the first electrodes.

2. The liquid ejection head according to claim 1, wherein
the first driving circuit includes a flexible circuit that is connected to the first electrodes by an anisotropic conductive film (ACF).

3. The liquid ejection head according to claim 1, wherein
the first driving circuit includes a flexible circuit that is connected to the first electrodes by solder.

4. The liquid ejection head according to claim 1, wherein
a dimension of the first base portion in a second direction along which the first actuator elements extend is 0.5 mm or more.

5. The liquid ejection head according to claim 1, further comprising:
a second electrode extending from another side surface of the first base portion that is opposite to said one side surface thereof to another side surface of each of the first actuator elements that is opposite to said one side surface thereof.

6. The liquid ejection head according to claim 1, further comprising:
a second actuator structure including a second base portion continuously extending along the first direction and a plurality of second actuator elements that are separate from each other, each of the second actuator elements extending from the second base portion to a corresponding one of the pressure chambers;
a plurality of third electrodes that are separate from each other, each of the third electrodes extending from one side surface of the second base portion to one side surface of a corresponding one of the second actuator elements; and
a second driving circuit connected to each of the third electrodes at the second base portion and configured to output a signal to the second actuator element corresponding to said each of the third electrodes.

7. The liquid ejection head according to claim 6, further comprising:
a fourth electrode extending from another side surface of the second base portion that is opposite to said one side surface thereof to another side surface of each of the second actuator elements that is opposite to said one side surface thereof.

8. The liquid ejection head according to claim 6, further comprising:
a substrate on which the first and second actuator structures are arranged along a third direction that is perpendicular to the first direction and parallel to the nozzle plate.

9. The liquid ejection head according to claim 1, wherein
a gap between two of the actuator elements that are adjacent to each other communicates with the pressure chambers.

10. The liquid ejection head according to claim 1, wherein
the first actuator elements include piezoelectric elements.

11. A liquid ejection apparatus comprising:
a conveyer configured to convey a medium; and
a liquid ejection head configured to eject liquid onto the conveyed medium, the liquid ejection head including:
a nozzle plate including a plurality of nozzles arranged in a first direction,
a plurality of pressure chambers arranged along the first direction and capable of storing the liquid, each of the pressure chambers communicating with a corresponding one of the nozzles,
a first actuator structure including a first base portion continuously extending along the first direction and a plurality of first actuator elements that are separate from each other, each of the first actuator elements extending from the first base portion to a corresponding one of the pressure chambers,
a plurality of first electrodes that are separate from each other, each of the first electrodes extending from one side surface of the first base portion to one side surface of a corresponding one of the first actuator elements, and
a first driving circuit connected to each of the first electrodes on said one side surface of the first base portion and configured to output signals for actuating the first actuator elements to the first electrodes.

12. The liquid ejection apparatus according to claim 11, wherein
the first driving circuit includes a flexible circuit that is connected to the first electrodes by an anisotropic conductive film (ACF).

13. The liquid ejection apparatus according to claim 11, wherein
the first driving circuit includes a flexible circuit that is connected to the first electrodes by solder.

14. The liquid ejection apparatus according to claim 11, wherein
a dimension of the first base portion in a second direction along which the first actuator elements extend is 0.5 mm or more.

15. The liquid ejection apparatus according to claim 11, wherein
the liquid ejection head further includes a second electrode extending from another side surface of the first base portion that is opposite to said one side surface thereof to another side surface of each of the first actuator elements that is opposite to said one side surface thereof.

16. The liquid ejection apparatus according to claim 11, wherein
the liquid ejection head further includes:
a second actuator structure including a second base portion continuously extending along the first direction and a plurality of second actuator elements that are separate from each other, each of the second actuator elements extending from the second base portion to a corresponding one of the pressure chambers,
a plurality of third electrodes that are separate from each other, each of the third electrodes extending from one side surface of the second base portion to one side surface of a corresponding one of the second actuator elements, and
a second driving circuit connected to each of the third electrodes at the second base portion and configured to output a signal to the second actuator element corresponding to said each of the third electrodes.

17. The liquid ejection apparatus according to claim 16, wherein
the liquid ejection head further includes a fourth electrode extending from another side surface of the second base portion that is opposite to said one side surface thereof to another side surface of each of the second actuator elements that is opposite to said one side surface thereof.

18. The liquid ejection apparatus according to claim 16, wherein
the liquid ejection head further includes a substrate on which the first and second actuator structures are arranged along a third direction that is perpendicular to the first direction and parallel to the nozzle plate.

19. The liquid ejection apparatus according to claim 11, wherein
a gap between two of the actuator elements that are adjacent to each other communicates with the pressure chambers.

20. The liquid ejection apparatus according to claim 11, wherein
the first actuator elements include piezoelectric elements.
